(19) United States
(12) Patent Application Publication
(10) Pub. No.: US 2018/0168161 A1
(43) Pub. Date: Jun. 21, 2018

(54) MICROPROPAGATION OF BLACK COHOSH

(71) Applicant: North Carolina Agricultural and Technical State University, Greensboro, NC (US)

(72) Inventors: Guochen Yang, Greensboro, NC (US); Zhongge Lu, Greensboro, NC (US)

(21) Appl. No.: 15/847,157

(22) Filed: Dec. 19, 2017

Related U.S. Application Data
(60) Provisional application No. 62/436,494, filed on Dec. 20, 2016.

(51) Int. Cl. A01N 43/90; A01N 43/82; A01N 37/10; A01N 43/38

(52) U.S. Cl. CPC A01N 43/90; A01N 43/38; A01N 37/10; A01N 43/82

(57) ABSTRACT

The presently disclosed subject matter provides a method for the micropropagation of black cohosh (Cimicifuga racemosa/Actaea racemose L.), using a combination of cytokinins and/or auxins to increase plantlet quality and accelerate plantlet production beyond what is observed in the wild.

### RELATED APPLICATIONS

This application claims priority under 35 U.S.C. § 119(e) to U.S. Provisional Patent Application Ser. No. 62/436,494, filed Dec. 20, 2016, the disclosure of which is incorporated herein by reference in its entirety.

### STATEMENT AS TO RIGHTS TO INVENTIONS MADE UNDER FEDERALLY SPONSORED RESEARCH OR DEVELOPMENT

This invention was made with government support under Grant Number 2015-33100-08912, awarded by the United States Department of Agriculture, National Institute of Food and Agriculture. The government has certain rights in the invention.

### FIELD

The present application relates to the micropropagation of black cohosh (Cimicifuga racemosa/Actaea racemose L.).

### BACKGROUND

Black cohosh has long been used by Native Americans for treatments of various ailments including various female conditions, rheumatism, malaria, general malaise, kidney malfunctioning, sore throat, snakebite, smallpox or chorea. Modern clinical research trials have suggested that medicinal effects of black cohosh include hypoglycemic, sedative, anti-inflammatory, antirheumatic, antispasmodic, alterative, antidote, astringent, cardiotonic, diaphoretic, diuretic, emmenagogue, expectorant, and vasodilator (Foster, S. Black cohosh: Cimicifuga racemosa. A literature review. HerbalGram. 1999; 45: 35-50.). Contemporary medicinal uses include, but are not limited to, the treatment of menopause symptoms such as hot flashes, heart palpitations, nervousness, irritability, sleep disturbances, tinnitus, vertigo, perspiration, and depression (Borrelli, F., et al. “Pharmacological effects of Cimicifuga racemosa.” Life Sciences 2003; 73: 1215-1229). Significant bioactive components of black cohosh include triterpene glycosides, acetein, and deoxyactein, and the isoflavone, formononetin. Compounds found in the root include aromatic acids, tannins, resins, and fatty acids (Greenfield et. al. “Black Cohosh (Actaea racemose L.) (2006) NC State University Horticulture Information Leaflets).

Black cohosh (Cimicifuga racemosa/Actaea racemose L.) was ranked as the eighth top selling herb in the United States with a reported value of $9.7 million in 2005. Heavy collection of this popular medicinal plant is a particular problem because such medicinal plants are normally slow-growing perennials. Production using black cohosh seeds can be unreliable because the seeds must be stratified and usually germinate over a period of two years after sowing. As a result of over-collection, black cohosh is a suitable candidate of endangered species in Appendix 2 of the Convention on International Trade in Endangered Species of Wild Fauna and Flora. The major threat to black cohosh populations is habitat destruction.

Agricultural biotechnology approaches including in vitro culture techniques, are particularly beneficial due to the potential for mass production of plants that are difficult to propagate, such as those with slow or low germination rates, including black cohosh.

The most popular approach for propagating black cohosh is rhizome (root) division. In this method, roots are harvested in the fall (typically when the seeds have completed their development and the leaves are dried). The harvested roots are then divided into several pieces, each containing at least one active bud used as the starting point to produce new individual plants. Prior attempts of in vitro growth techniques for black cohosh, include, for example, Lata et al. “In vitro Plant Regeneration from Leaf-Derived Callus of Cimicifuga racemose” Planta Med 2002; 68(10): 912-915; and Pinker, I. and Schenk, R. “Somatic Embryogenesis in Cimicifuga Racemosa.” Acta Hortic. 2007, 764: 265-270; each of which rely on the formation of a callus. However, a number of propagation issues remain, including successful direct organogenesis that does not proceed by way of a callus stage.

Accordingly, an efficient propagation protocol to produce high quality black cohosh plants in a short period without production of a callus is still needed, as is a process that allows for efficient production with enhanced seedling quality.

### SUMMARY

In some aspects, the presently disclosed subject matter provides a method for the propagation of black cohosh, comprising: (a) culturing a leaf or portion thereof from a black cohosh plant in a shoot initiation culture medium comprising at least one auxin and at least one phenyl-urea based cytokinin, wherein the culture is kept in dark conditions for more than about 2 weeks; (b) replacing the shoot initiation culture medium with a shoot proliferation culture medium and culturing for at least about 4 weeks; and (c) replacing the shoot proliferation culture medium with a rooting culture medium comprising at least one auxin.

In some aspects, the presently disclosed subject matter provides a method for the propagation of black cohosh, comprising: (a) culturing a leaf or portion thereof from a black cohosh plant in a shoot initiation culture medium comprising naphthalene acetic acid and thidiazuron, wherein the culture is kept in dark conditions for at least about 3 weeks, yielding an initiated shoot; (b) culturing the initiated shoot for at least about 4 weeks with a shoot proliferation culture medium comprising 6-benzylaminopurine and naphthalene acetic acid, wherein the shoot proliferation culture is exposed to at least about 8 hours of light per day, yielding a proliferated shoot; and (c) culturing the proliferated shoot for at least about 2 weeks with a rooting culture medium comprising indole-3-butyric acid, wherein the rooting culture is exposed to at least about 8 hours of light per day.

Accordingly, the presently disclosed subject matter provides methods of propagating black cohosh. These and other objects and aspects of the presently disclosed subject matter will become apparent to those skilled in the art after a reading of the following description of the disclosure.

### BRIEF DESCRIPTION OF THE DRAWINGS

FIG. 1 is a schematic diagram describing exemplary media conditions for methods of the presently disclosed subject matter. “TDZ” refers to thidiazuron; “NAA” refers to naphthalene acetic acid; “PGR” refers to plant growth regulators; “BA” refers to 6-benyzlaminopurine; and “IBA” refers to indole-3-butyric acid.

### DETAILED DESCRIPTION

In accordance with the present application and as used herein, the following terms are defined with the following meanings, unless explicitly stated otherwise.

Following long-standing patent law convention, the terms “a”, “an”, and “the” refer to “one or more” when used in this application, including the claims. The term “and/or” when used in describing two or more items or conditions, refers to situations where all named items or conditions are present or applicable, or to situations wherein only one (or less than all) of the items or conditions is present or applicable. The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “comprising”, which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim. As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole. As used herein, the phrase “consisting essentially of” limits the scope of a claim to the specified materials or steps, plus those that do not materially affect the basic and novel characteristic(s) of the claimed subject matter. With respect to the terms “comprising”, “consisting of”, and “consisting essentially of”, where one of these three terms is used herein, the presently disclosed subject matter can include the use of either of the other two terms.

Unless otherwise indicated, all numbers expressing quantities of time, concentration, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter. As used herein, the term “about”, when referring to a value is meant to encompass variations of in one example ±20% or ±10%, in another example ±5%, in another example ±1%, and in still another example ±0.1% from the specified amount, as such variations are appropriate to perform the disclosed methods.

As used herein, ‘black cohosh’ refers to both Cimicifuga racemosa and Actaea racemose L. Common names for black cohosh include, but are not limited to, black bugbane, black snakeroot, and fairy candle.

As used herein, a ‘base medium’ or “plant growth medium” refers to a plant growth medium comprising supplements, generally as defined in the literature references.

Such base media include, but are not limited to MS Base Medium (Murashige, T. and Skoog F., “A revised medium for rapid growth and bioassays with tobacco tissue cultures.” Physiol. Plant. 1962; 15: 473-497), LS medium (Linsmaier and Skoog, “Organic growth factor requirements of tobacco tissue cultures” Physiol. Plant. 1965; 18: 100-127), Woody Plant Medium (“WPM”; Lloyd, G. and McCown, B. H. Proc. Int. Plant Prop. Soc. 1981; 30: 421-427), White's medium (White, P. R. “The cultivation of animal and plant cells” Ronald Press CO, New York, 1963), SH medium (Schenk R. U. and Hildebrandt A. C. “Medium and techniques for induction and growth of monocotyledonous and dicotyledonous plant cell cultures.” Can. J. Bot. 1972; 50: 199-204) and DWK medium (Hammatt and Grant, “Shoot regeneration from leaves of Prunus serotina Ehrh. (black cherry) and P. avium L. (wild cherry)” Plant Cell Rep. 1998; 17: 526-530). Natural products such as potatoes can also been used as base media.

Plant growth media disclosed herein can contain a gelling agent, or “substrate” such as the polysaccharides agar or gellan gum, (Gelrite®, AppliedGel®, or Phytagel®). Alternative support materials include, but are not limited to, perforated cellophane, filter paper bridges, filter paper wicks, polyurethane foam, and polyester fleece. Generally, the substrate is agar.

Additional compounds that can supplement the medium according to the presently disclosed methods include a suitable carbon source, such as a sugar compound, for example, sucrose, glucose, fructose, lactose, galactose, rafinose, maltose, and starch or a combination thereof.

Compounds that can further supplement the media disclosed herein include but are not limited to: vitamins, such as thiamin (B1), nicotinic acid, pyridoxine (B6), and inositol and its isomers such as myo-inositol, biotin, folic acid, ascorbic acid, pantothenic acid, vitamin E, riboflavin, and p-aminobenzoic acid. Amino acids, for example, L-glutamine, L-asparagine, cysteine, and adenine, as well as amino acid mixtures (e.g., casein hydrolysate) can also be added.

The rooting media disclosed herein can be supplemented with activated charcoal. Without being bound by theory, activated charcoal is generally believed to darken the medium to mimic growth in soil. Activated charcoal is also believed to absorb compounds, such as phenolics, which are produced by the growing plant and can inhibit plant growth in the culture medium. In one variation of the disclosed technology, activated charcoal is not a component of the rooting medium. In another variation, activated charcoal is used in the rooting medium.

As used herein “MS supplemented base medium” refers to MS Base Medium supplemented with a substrate and a sugar compound, and optionally with one or more plant growth regulators as disclosed herein. The pH of the medium is usually between about 5.5 and about 6.5 or alternately between about 5 and about 6. In some embodiments, the pH is adjusted to between about 5.4 and about 5.8, or to about 5.5. Generally, the pH of MS supplemented medium is adjusted with a base, such as 1N KOH, and/or an acid, such as 1N HCl, before the agar is added. Typically, a supplemented medium is sterilized by autoclaving. Alternately, a simple pressure cooker can be used to sterilize the medium, or still further, the medium can be sterilized via membrane filtration or other sterilization methods known to those of skill in the art.

As used herein, a ‘plantlet’ refers to a plant that has at least one true leaf and root growth. Generally, in a plantlet, the leaf and the root are each at least about 1.5 cm in length. In some embodiments, the plantlet can be about 3-4 cm in overall length. Plantlets can be found, for example, emerging from a germinated seed or resulting from the growth of a root from a viable shoot in a plant growth medium. A shoot containing one true leaf is generally referred to as a “viable shoot.”

In the methods disclosed herein, a growth chamber is typically used to control the growth environment and maintain a consistent temperature for the growth media.

As disclosed herein, “dark conditions” generally refer to keeping a culture medium in minimal light, such as for example, no more than the time needed to check shoot growth or root growth progress and/or to confirm a lack of contamination. Such observation can require no more than about 5 minutes exposure to light, or no more than about 10 minutes, or 15 minutes or 20 minutes. In some examples, dark conditions mean that the culture medium is not exposed to daylight at all; in other examples, the culture medium is only exposed to a minimal amount of daylight, such as less than about 2 hours, less than about 1 hour, less than about 30 minutes, less than about 15 minutes, or less than about 10 minutes per day.

As disclosed herein, “light conditions” generally refer to providing a culture medium or plant regular access to light. Typically, in a growth chamber, light conditions include 16 hours of light in a 24 hour period (“16-hour photo period”). Generally, light conditions are characterized by a photo flux density of 37.6±4.8 μmol s⁻¹m⁻² light per day provided by cool white fluorescent tubes at 23±0.1° C., but variations can be employed.

Once plantlets have been transferred to soil, typical growth conditions are provided for via exposure to sunlight within a greenhouse, for example, 60% shade, or about 50% shade, wherein “shade” refers to the degree of filtering of natural sunlight. Generally, black cohosh plantlets and plants can be grown in about 50% shade conditions. Alternately, the plantlets and plants can be grown in about 60%, 70%, 80% or even 90% shade conditions.

Generally in preparation for growth under aseptic conditions, young tender leaves from black cohosh plants are disinfected, for example in a bleach solution (e.g. 15-20 minutes in a 15% bleach) optionally containing Tween (e.g. 20 drops per liter). Other solutions for disinfecting leaves familiar to those of skill in the art can also be used. The disinfected leaves are then rinsed, generally multiple times, using sterile water (purchased e.g. from Sigma Aldrich, St. Louis, Mo. or prepared e.g. in an autoclave or pressure cooker), cut into dime-sized squares, and transferred to a container containing a base medium, agar, a sugar compound, and plant growth regulators as disclosed herein.

Initially, disinfected black cohosh leaves are cultured on a shoot initiation culture comprising a supplemented base medium and a phenyl urea based cytokinin-like plant growth regulator and a synthetic auxin plant growth regulator. In some embodiments, the phenyl urea based cytokinin-like plant growth regulator is thidiazuron (TDZ). In some embodiments, TDZ is used at a concentration (in units of milligram TDZ per liter media) of between about 0.01 mg/L and about 6.0 mg/L, between about 0.25 mg/L and about 5.0 mg/L, between about 0.01 mg/L and about 2.0 mg/L, or between about 0.75 mg/L and about 1.5 mg/L, or at a concentration of about 0.5 mg/L, about 1.0 mg/L, about 1.5 mg/L, or about 2.0 mg/L. In some embodiments, the synthetic auxin plant growth regulator is naphthalene acetic acid (NAA). In some embodiments, NAA is used at a concentration (in units of milligram NAA per liter media) of between about 0.01 mg/L and about 0.25 mg/L, between about 0.05 mg/L and about 0.5 mg/L, between about 0.075 mg/L and about 0.25 mg/L, or between about 0.075 mg/L and about 0.15 mg/L, or at a concentration of about 0.075 mg/L, about 0.1 mg/L, about 0.15 mg/L or about 0.2 mg/L. The leaves are kept in the shoot initiation culture medium under dark conditions for at least about 2 weeks. In some embodiments, the leaves are kept in the shoot initiation culture medium for more than about 2 weeks (e.g., for at least 15, 16, 17, 18, 19, or 20 days). In some embodiments, the leaves are kept in the shoot initiation culture medium for at least about 3 weeks, at least about 4 weeks, or at least about 5 weeks. In some embodiments, the leaves are cultured in the dark for between more than about two weeks and about six weeks or less or between about three weeks and about five weeks. In some embodiments, the leaves are kept in the shoot initiation medium under dark conditions for about 4 weeks. After a shoot initiation period in the dark, the cultures are generally moved to fresh MS supplemented base medium containing TDZ and NAA in amounts outlined above and kept in a growth chamber under 16 hours/day light conditions for at least about 3 weeks, at least about 4 weeks, or at least about 5 weeks. In some embodiments, the leaves are cultured under light conditions for between about two weeks and about six weeks or between about three weeks and about five weeks, or for about 4 weeks.

Compounds belonging to the cytokinin family of growth regulators which can be used according to the presently disclosed methods include, but are not limited to, purin-based cytokinins, such as, for example, kinetin (N-(2-furanylmethyl)-1H-purin-6-amine, or N⁶-furfuryladenine), zeatin (6-(4-hydroxy-3-methy-trans-2-butenylamino)purine), 6-benzylamino purine (BAP or benzyladenine, BA); 6-(benzylamino)-9-(2-tetrahydropyrany10-9h-purine (PBA); or (6-(γγ-dimethyl-allylamino)purine (2iP); and cytokinins based on substituted phenyl ureas, such as, for example, thidiazuron (TDZ), diphenylurea, and N-(2-chloro-4-pyridyl)-N1-phenylurea (CPPU), or combinations thereof. Naturally occurring compounds, including adenine which has a base structure similar to that of the cytokinins and has shown cytokinin-like activity in some cases, can additionally be used as supplemental growth regulators. In some embodiments, cytokinins are used in concentrations between about 0.1 μM and about 50 μM. In some embodiments, the concentration is between about 0.5 μM and about 40 μM or between about 1 μM and about 30 μM or between about 2 μM and about 25 μM or between about 5 μM and about 15 μM, or between about 0.5 μM and about 15 μM. For example, in some embodiments, the cytokinin concentration can be about 0.1 μM, about 0.2 μM, about 0.3 μM, about 0.4 μM, about 0.5 μM, about 0.75 μM, about 1 μM, about 1.5 μM, about 2 μM, about 3 μM, about 4 μM, about 5 μM, about 6 μM, about 7 μM, about 7.5 μM, about 8 μM, about 9 μM, about 10 μM, about 11 μM, about 12 μM, about 12.5 μM, about 13 μM, about 14 μM, about 15 μM, about 17.5 μM, about 20 μM, about 25 μM, about 30 μM, about 35 μM, about 40 μM, about 45 μM, or about 50 μM.

Compounds belonging to the auxin family of growth regulators which can be used according to the present application include, but are not limited to, indole-3-butyric acid (IBA); α-naphthaleneacetic acid (NAA); indole-3-acetic-acid (IAA); 4-chloroindole-3-acetic acid (4-Cl-IAA); 4-chlorophenoxyacetic acid (4-CPA, PCPA); (2,4,5-trichlorophenoxy)acetic acid (2,4,5-T); 3,6-dichloro-2-methoxybenzoic acid (Dicamba); and 4-amino-3,5,6-trichloropicolinic acid (Picloram) or combinations thereof. In some embodiments, auxins are used in concentrations between about 0.1 μM and about 50 μM. In some embodiments, the concentration is between about 0.5 μM and about 40 μM or between about 1 μM and about 30 μM or between about 2 μM and about 25 μM or between about 5 μM and about 15 μM, or between about 0.5 μM and about 15 μM. In some embodiments, auxin concentration can be about 0.1 μM, about 0.2 μM, about 0.3 μM, about 0.4 μM, about 0.5 μM, about 0.75 μM, about 1 μM, about 1.5 μM, about 2 μM, about 3 μM, about 4 μM, about 5 μM, about 6 μM, about 7 μM, about 7.5 μM, about 8 μM, about 9 μM, about 10 μM, about 11 μM, about 12 μM, about 12.5 μM, about 13 μM, about 14 μM, about 15 μM, about 17.5 μM, about 20 μM, about 25 μM, about 30 μM, about 35 μM, about 40 μM, about 45 μM, or about 50 μM.

Following the initial shoot initiation step, the initiated shoots are transferred to a shoot proliferation culture comprising a supplemented growth medium comprising a base plant growth medium (eg. WPM, MS, or LS media), a sugar compound, and agar and which is supplemented with one or more plant growth regulators selected from the group comprising synthetic auxin plant growth regulators and/or purin-based cytokinins. In one example, the auxin is NAA; in another example, the purin-based cytokinin is selected from the group comprising BA and kinetin. In another example, the plant growth regulators are used in combination, e.g., the shoot proliferation medium is supplemented with BA and NAA or is supplemented with kinetin and NAA. In some embodiments, NAA is used at a concentration of between about 0.05 mg/L and about 0.5 mg/L, or between about 0.075 mg/L and about 0.25 mg/L, or between about 0.075 mg/L and about 0.15 mg/L, or at a concentration of about 0.075 mg/L, about 0.1 mg/L, about 0.15 mg/L, or about 0.2 mg/L. In some embodiments, the purin-based cytokinin, BA and/or kinetin is used at a concentration of between about 0.01 mg/L and about 6.0 mg/L, or between about 0.25 mg/L and about 5.0 mg/L, or between about 0.5 mg/L and about 2.0 mg/L, or between about 0.75 mg/L and about 1.5 mg/L, or at a concentration of about 0.5 mg/L, about 1.0 mg/L, about 1.5 mg/L, or about 2.0 mg/L. The shoots are kept in the shoot proliferation culture medium under 16-hour photoperiod for at least about 2 weeks, at least about 4 weeks, at least about 6 weeks, at least about 8 weeks, at least about 12 weeks, or even at least about 16 weeks, typically between about four weeks and about twelve weeks. In some embodiments, the shoots are kept in the shoot proliferation medium for at least about 4 weeks. In some embodiments, the shoots are kept in the shoot proliferation culture medium under less than a 16-hour photoperiod, for example for a 14-hour photoperiod, or a 12-hour photoperiod, or a 10-hour or even an 8-hour photoperiod.

Following the initial shoot proliferation step, the proliferated shoots are transferred to a rooting culture made up of a supplemented growth medium comprising a base plant growth medium (eg. WPM, MS, or LS media), a sugar compound, and agar and supplemented with plant growth regulators selected from the group comprising synthetic auxin plant growth regulators. In one example, the auxin is NAA; in another example, the auxin is IBA; in yet another example, the auxin is a combination of NAA and IBA. In some embodiments, in the rooting medium, an auxin is used at a concentration of between about 0.05 mg/L and about 5.0 mg/L, or between about 0.1 mg/L and about 2.5 mg/L, or between about 0.075 mg/L and about 0.15 mg/L, or at a concentration of about 0.05 mg/L, about 0.1 mg/L, about 0.5 mg/L, about 1.0 mg/L, about 1.5 mg/L or about 2.0 mg/L.

In some aspects, the presently disclosed subject matter provides a method for the propagation of black cohosh, comprising: (a) culturing a leaf or portion thereof from a black cohosh plant in a shoot initiation culture medium comprising at least one auxin and at least one phenyl-urea based cytokinin, wherein the culture is kept in dark conditions for more than about 2 weeks; (b) replacing the shoot initiation culture medium with a shoot proliferation culture medium and culturing for at least about 4 weeks; and (c) replacing the shoot proliferation culture medium with a rooting culture medium comprising at least one auxin.

In some aspects, the presently disclosed subject matter provides a method for the propagation of black cohosh, comprising: (a) culturing a leaf or portion thereof from a black cohosh plant in a shoot initiation culture medium comprising naphthalene acetic acid and thidiazuron, wherein the culture is kept in dark conditions for at least about 3 weeks, yielding an initiated shoot; (b) culturing the initiated shoot for at least about 4 weeks with a shoot proliferation culture medium comprising 6-benzylaminopurine and naphthalene acetic acid, wherein said shoot proliferation culture is exposed to at least about 8 hours of light per day, yielding a proliferated shoot; and (c) culturing the proliferated shoot for at least about 2 weeks with a rooting culture medium comprising indole-3-butyric acid, wherein the rooting culture is exposed to at least about 8 hours of light per day.

In some embodiments, the at least one auxin in the shoot initiation culture medium is naphthalene acetic acid (NAA) and/or the at least one phenyl-urea based cytokinin in the shoot initiation culture medium is thidiazuron (TDZ). In some variations, the shoot initiation culture medium comprises between about 0.01 mg/L and about 0.25 mg/L NAA and/or between about 0.25 mg/L and about 5.0 mg/L TDZ. In some embodiments, the shoot initiation culture medium comprises between about 0.25 mg/L and about 5.0 mg/L TDZ or between about 0.5 mg/L and about 2.5 mg/L TDZ. In some embodiments, the shoot initiation culture medium comprises about 1.0 mg/L TDZ. In some embodiments, the shoot initiation culture medium comprises between about 0.01 mg/L and about 0.25 mg/L NAA or between about 0.05 mg/L and about 0.15 mg/L NAA. In some embodiments, the shoot initiation culture medium comprises about 0.1 mg/L NAA. In some embodiments, the shoot initiation culture medium comprises between about 0.25 mg/L and about 5.0 mg/L TDZ and between about 0.01 mg/L and about 0.25 mg/L NAA.

In other embodiments, the shoot proliferation culture medium comprises naphthalene acetic acid (NAA) and/or 6-benzylaminopurine (BA). In still other embodiments, the shoot proliferation culture medium comprises NAA and/or kinetin. In one variation of any aspect or embodiment, the shoot proliferation culture medium comprises NAA. In another such variation, the shoot proliferation culture medium comprises BA or kinetin. In another variation, the shoot proliferation culture medium comprises BA and NAA; in yet another variation, the shoot proliferation culture medium comprises kinetin and NAA. In some embodiments, the shoot proliferation culture medium comprises between about 0.01 mg/L and about 0.25 mg/L NAA or between about 0.05 mg/L and about 0.15 mg/L NAA. In some embodiments, the shoot proliferation culture medium comprises about 0.1 mg/L NAA. In some embodiments, the shoot proliferation culture medium comprises between about 0.25 mg/L and about 5.0 mg/L BA or between about 0.5 mg/L and about 2.5 mg/L BA. In some embodiments, the shoot proliferation culture medium comprises about 1.0 mg/L BA. In some embodiments, the shoot proliferation culture medium comprises between about 0.25 mg/L and about 5.0 mg/L kinetin or between about 0.5 mg/L and about 2.5 mg/L kinetin. In some embodiments, the shoot proliferation culture medium comprises about 1.0 mg/L kinetin. In some variations, the shoot proliferation culture medium comprises between about 0.01 mg/L and about 0.25 mg/L NAA and/or between about 0.25 mg/L and about 5.0 mg/L BA. In other variations, the shoot proliferation culture medium comprises between about 0.01 mg/L and about 0.25 mg/L NAA and/or between about 0.25 mg/L and about 5.0 mg/L kinetin.

In yet another variation of any aspect or embodiment, the at least one auxin in the rooting culture medium is indole-3-butyric acid (IBA). In other variations, the rooting culture medium comprises between about 0.25 mg/L and about 5.0 mg/L IBA or between about 0.5 mg/L and about 2.5 mg/L IBA. In some embodiments, the rooting culture medium comprises about 1.0 mg/L IBA.

In some variations of any aspect or embodiment, the shoot initiation culture is kept in dark conditions for at least about 3 weeks, or at least about 4 weeks. In other variations of any aspect or embodiment, the initiated shoot is cultured in a shoot proliferation medium comprising BA and NAA for at least about 8 weeks, wherein said shoot proliferation culture is exposed to at least about 8 hours of light per day, yielding a proliferated shoot. In some variations, the proliferated shoot is cultured in the rooting culture medium for at least about 4 weeks.

In some embodiments, the shoot initiation culture medium comprises between about 0.25 mg/L and about 5.0 mg/L thidiazuron and between about 0.01 mg/L and about 0.25 mg/L naphthalene acetic acid, wherein the culture is kept in dark conditions for at least about 4 weeks; the shoot proliferation culture medium comprises between about 0.01 mg/L and about 0.25 mg/L naphthalene acetic acid and between about 0.25 mg/L and about 5.0 mg/L 6-benzylaminopurine, wherein said shoot proliferation culture is exposed to at least about 8 hours of light per day and is cultured for at least about 8 weeks; and the rooting culture medium comprises between about 0.25 mg/L and about 5.0 mg/L indole-3-butyric acid, wherein the rooting culture is exposed to at least about 8 hours of light per day and is cultured for at least about 4 weeks.

In some embodiments, the shoot initiation culture medium comprises about 1.0 mg/L thidiazuron and about 0.1 mg/L naphthalene acetic acid; the shoot proliferation culture medium comprises about 0.1 mg/L naphthalene acetic acid and about 1.0 mg/L 6-benzylaminopurine; and the rooting culture medium comprises between about 1.0 mg/L indole-3-butyric acid.

### EXAMPLES

Materials and Methods

Leaves were collected from black cohosh plants growing in the North Carolina A&T State University greenhouse. The leaves were cut into dime-sized squares and disinfected in a 20% bleach solution plus 20 drops Tween-20 per liter for 20 minutes and then rinsed immediately 3 times with sterile distilled water.

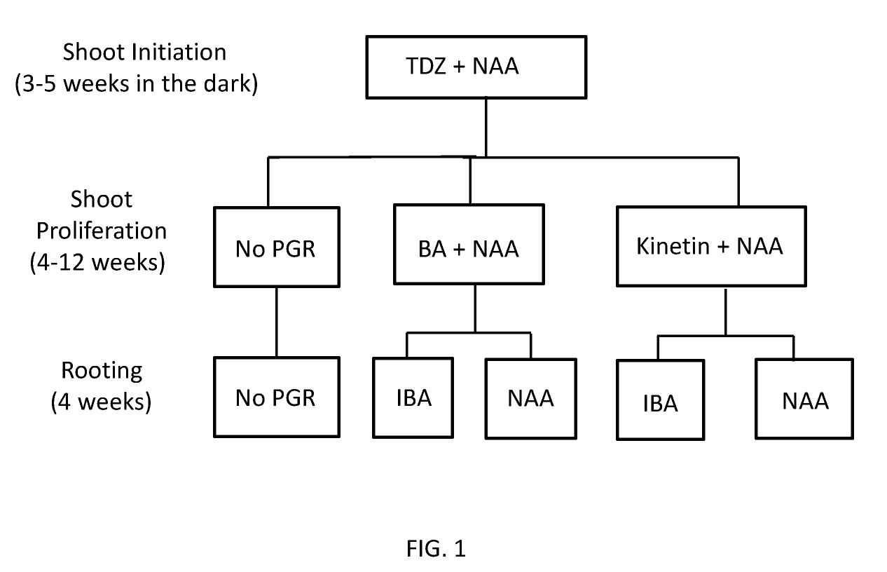

All cultures described herein were transferred onto fresh media every 4 weeks. When indicated as such, the cultures were maintained in a plant tissue culture grade growth chamber under a 16-hour photoperiod (e.g. 16 hours of light per a 24 hour period) with a photo flux density of 37.6±4.8 μmol s⁻¹m⁻² light per day provided by cool white fluorescent tubes at 23±0.1° C., unless otherwise noted. See FIG. 1.

As employed herein, MS supplemented base medium is at a pH of between about 5.4 and 5.8, supplemented with about 0.7% agar and about 3% sucrose, optionally with one or more plant growth regulators as disclosed herein. The pH of the medium is adjusted with a base, such as 1N KOH, and/or an acid, such as 1N HCl, before the agar is added. The supplemented medium is sterilized by autoclaving at about 120° C. and about 106 kPa for about 20 minutes.

### Example 1—Shoot Initiation

The leaves were prepared according to Materials and Methods above.

In the shoot initiation step, the leaves were cultured on an MS supplemented base medium containing TDZ (1.0 mg/1) and NAA (0.1 mg/1) in a growth chamber under completely dark conditions for 4 weeks. See also the top row of FIG. 1, which refers to shoot initiation using TDZ+NAA for 3-5 weeks in the dark.

The cultures were then moved to fresh MS supplemented base medium containing TDZ (1.0 mg/1) and NAA (0.1 mg/1) and kept in a growth chamber under 16 hours/day light conditions for 4 weeks.

### Example 1A—Shoot Proliferation

After the shoot initiation, one third of the cultures from Example 1 were moved to fresh MS supplemented base medium with no plant growth regulators (“PGR”) and kept in a growth chamber under 16 hours light conditions per day for up to 12 weeks to achieve shoot proliferation. Growth was monitored at four-week intervals when the culture was transferred onto fresh supplemented base medium with no plant growth regulators (“PGR”). Weak shoot proliferation was observed. See also the middle row of FIG. 1, which refers to shoot proliferation for 4-12 weeks.

### Example 1A(i)—Rooting

The cultures from Example 1A were moved to fresh MS supplemented base medium containing no plant growth regulators and kept in a growth chamber under 16 hours light conditions per day for 4 weeks for rooting. See also the bottom row of FIG. 1, which refers to rooting for 4 weeks.

Growth of the plantlets in Example 1A and 1A(i), in the absence of added plant growth regulators, was not deemed successful. In particular, the shoot growth that was initiated in the presence of TDZ and NAA did not proliferate in Example 1A and only small amount of roots were observed in Example 1A(i).

### Example 1B— Shoot Proliferation

After the shoot initiation, another third of the cultures from Example 1 were moved to fresh MS supplemented base medium containing BA (1.0 mg/1) and NAA (0.1 mg/1). The culture was kept in a growth chamber under 16 hours light conditions per day for up to 12 weeks. Growth was monitored every four weeks when the culture was transferred onto fresh supplemented base medium containing BA (1.0 mg/1) and NAA (0.1 mg/1). At four weeks, generally good shoot proliferation was observed. See also the middle row of FIG. 1, which refers to shoot proliferation for 4-12 weeks.

### Example 1B(i)—Rooting

A first half of the cultures from Example 1B were moved to fresh MS supplemented base medium containing IBA (1.0 mg/1) and kept in a growth chamber under 16 hours light conditions per day for 4 weeks for rooting of the plantlets. See also the bottom row of FIG. 1, which refers to rooting for 4 weeks.

The micropropagated plantlets were then transferred to soil, where they grew vigorously with normal morphology under typical shade conditions (60%).

### Example 1B(ii)—Rooting

A second half of the cultures from Example 1B were moved to fresh MS supplemented base medium containing NAA (0.1 mg/1) and kept in a growth chamber under 16 hours light conditions per day for 4 weeks for rooting of the plantlets. See also the bottom row of FIG. 1, which refers to rooting for 4 weeks.

The micropropagated plantlets were then transferred to soil, where they grew under typical shade conditions (60%). The growth of these plantlets was not as robust as that observed in Example 1B(i)

### Example 1C— Shoot Proliferation

The final third of the cultures from Example 1 were moved to fresh MS supplemented base medium containing kinetin (1.0 mg/1) and NAA (0.1 mg/1) and kept in a growth chamber under 16 hours light conditions per day for up to 12 weeks (see the middle row of FIG. 1, which refers to shoot proliferation for 4-12 weeks), sometimes up to 16 weeks with monitoring every four weeks when the culture was transferred onto fresh supplemented base medium containing kinetin (1.0 mg/1) and NAA (0.1 mg/1). At four weeks, generally good shoot proliferation was observed and proceeded during the following weeks of proliferation. The growth was continued in some instances for up to 16 weeks.

These samples initially appeared to progress better than samples in Example 1A and about the same as the samples in 1B.

### Example 1C(i)—Rooting

A first half of the cultures from Example 1C were moved to fresh supplemented MS base medium containing IBA (1.0 mg/1) and kept in a growth chamber under 16 hours light conditions per day for 4 weeks for rooting. See also the bottom row of FIG. 1, which refers to rooting for 4 weeks.

The micropropagated plantlets were then transferred to soil, where they grew vigorously under typical shade conditions (60%).

### Example 1C(ii)—Rooting

A second half of the cultures from Example 1C were moved to fresh MS supplemented base medium containing NAA (0.1 mg/1) and kept in a growth chamber under 16 hours light conditions per day for 4 weeks for rooting. See also the bottom row of FIG. 1, which refers to rooting for 4 weeks.

The micropropagated plantlets were then transferred to soil, where they grew under typical shade conditions (60%). The plantlet growth appeared to be less robust than the growth of the plantlets in Example 1C(i).

### Example 2

Black cohosh leaves were prepared according to Materials and Methods above.

In the shoot initiation step, the leaves were cultured on an MS supplemented base medium containing TDZ (1.0 mg/1) and NAA (0.1 mg/1) in a growth chamber under completely dark conditions for 2 weeks and moved to under light conditions for 2-4 weeks. The initiated shoots were not deemed robust enough to move forward.

### Example 3

Black cohosh leaves were prepared according to Materials and Methods above.

In the shoot initiation step, the leaves were cultured on an MS supplemented base medium containing TDZ (1.0 mg/1) and NAA (0.1 mg/1) in a growth chamber under completely dark conditions for 3 weeks.

The leaves were then processed according to the methods of Example 1.

### Example 4

Black cohosh leaves were prepared according to Materials and Methods above.

In the shoot initiation step, the leaves were cultured on an MS supplemented base medium containing TDZ (1.0 mg/1) and NAA (0.1 mg/1) in a growth chamber under completely dark conditions for 5 weeks.

The leaves were then processed according to the methods of Example 1.

### Example 5

Black cohosh leaves were prepared according to Materials and Methods above.

In the shoot initiation step, the leaves were cultured on an MS supplemented base medium containing TDZ (1.0 mg/1) and NAA (0.1 mg/1) in a growth chamber under completely dark conditions for 6 weeks. The initiated shoots were not deemed robust enough to move forward.

In a comparison of the growth of plantlets resulting from micropropagation methods identified herein, success was observed from shoot initiation in the presence of TDZ and NAA in the dark for at least about 4 weeks; shoot proliferation in each of BA+NAA or BA+kinetin yielded well-proliferated shoots after 4 weeks and the shoots could be allowed to grow up to 12 weeks in the shoot proliferation culture. Plantlet growth from examples using NAA in the rooting step was less robust than the corresponding examples using IBA in the rooting step.

The patents and publications listed herein describe the general skill in the art and are hereby incorporated by reference in their entireties for all purposes and to the same extent as if each was specifically and individually indicated to be incorporated by reference. In the case of any conflict between a cited reference and this specification, the specification shall control. In describing embodiments of the present application, specific terminology is employed for the sake of clarity. However, the invention is not intended to be limited to the specific terminology so selected. Nothing in this specification should be considered as limiting the scope of the present invention. All examples presented are representative and non-limiting. The above-described embodiments may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A method for the propagation of black cohosh, comprising:
a. culturing a leaf or portion thereof from a black cohosh plant in a shoot initiation culture medium comprising at least one auxin and at least one phenyl-urea based cytokinin, wherein the culture is kept in dark conditions for more than about 2 weeks;
b. replacing the shoot initiation culture medium with a shoot proliferation culture medium and culturing for at least about 4 weeks; and
c. replacing the shoot proliferation culture medium with a rooting culture medium comprising at least one auxin.

2. The method of claim 1 wherein the at least one auxin in the shoot initiation culture medium is naphthalene acetic acid and/or the at least one phenyl-urea based cytokinin in the shoot initiation culture medium is thidiazuron.

3. The method of claim 2, wherein the shoot initiation culture medium comprises between about 0.01 mg/L and about 0.25 mg/L naphthalene acetic acid and/or between about 0.25 mg/L and about 5.0 mg/L thidiazuron.

4. The method of claim 2, wherein the shoot initiation culture is kept in dark conditions for at least about 4 weeks.

5. The method of claim 1, wherein the shoot proliferation culture medium comprises naphthalene acetic acid and/or 6-benzylaminopurine.

6. The method of claim 5, wherein the shoot proliferation culture medium comprises between about 0.01 mg/L and about 0.25 mg/L naphthalene acetic acid and/or between about 0.25 mg/L and about 5.0 mg/L 6-benzylaminopurine.

7. The method of claim 5, wherein the shoot initiation culture is kept in dark conditions for at least about 4 weeks.

8. The method claim 1, wherein the rooting culture medium comprises between about 0.25 mg/L and about 5.0 mg/L indole-3-butyric acid.

9. The method claim 8, wherein the shoot initiation culture is kept in dark conditions for at least about 4 weeks.

10. A method for the propagation of black cohosh, comprising:
a. culturing a leaf or portion thereof from a black cohosh plant in a shoot initiation culture medium comprising naphthalene acetic acid and thidiazuron, wherein the culture is kept in dark conditions for at least about 3 weeks, yielding an initiated shoot;
b. culturing the initiated shoot for at least about 4 weeks with a shoot proliferation culture medium comprising 6-benzylaminopurine and naphthalene acetic acid, wherein said shoot proliferation culture is exposed to at least about 8 hours of light per day, yielding a proliferated shoot;
c. culturing the proliferated shoot for at least about 2 weeks with a rooting culture medium comprising indole-3-butyric acid, wherein said rooting culture is exposed to at least about 8 hours of light per day.

11. The method of claim 10, wherein the shoot initiation culture medium comprises between about 0.25 mg/L and about 5.0 mg/L thidiazuron and between about 0.01 mg/L and about 0.25 mg/L naphthalene acetic acid.

12. The method of claim 10, wherein the shoot proliferation culture medium comprises between about 0.01 mg/L and about 0.25 mg/L naphthalene acetic acid and between about 0.25 mg/L and about 5.0 mg/L 6-benzylaminopurine.

13. The method of claim 10, wherein the rooting culture medium comprises between about 0.25 mg/L and about 5.0 mg/L indole-3-butyric acid.

14. The method of claim 10, wherein the shoot initiation culture is kept in dark conditions for between about 3 and about 5 weeks.

15. The method of claim 10, wherein the shoot initiation culture is kept in dark conditions for at least about 4 weeks.

16. The method of claim 10, wherein culturing the initiated shoot with a shoot proliferation culture medium comprises culturing for at least about 8 weeks.

17. The method of claim 10, wherein culturing the proliferated shoot with a rooting culture medium comprises culturing for at least about 4 weeks.

18. The method of claim 10, wherein:
a. the shoot initiation culture medium comprises between about 0.25 mg/L and about 5.0 mg/L thidiazuron and between about 0.01 mg/L and about 0.25 mg/L naphthalene acetic acid, wherein the culture is kept in dark conditions for at least about 4 weeks;
b. the shoot proliferation culture medium comprises between about 0.01 mg/L and about 0.25 mg/L naphthalene acetic acid and between about 0.25 mg/L and about 5.0 mg/L 6-benzylaminopurine, wherein said shoot proliferation culture is exposed to at least about 8 hours of light per day and is cultured for at least about 8 weeks; and
c. the rooting culture medium comprises between about 0.25 mg/L and about 5.0 mg/L indole-3-butyric acid, wherein said rooting culture is exposed to at least about 8 hours of light per day and is cultured for at least about 4 weeks.

19. The method of claim 10, wherein:
a. the shoot initiation culture medium comprises about 1.0 mg/L thidiazuron and about 0.1 mg/L naphthalene acetic acid;
b. the shoot proliferation culture medium comprises 0.1 mg/L naphthalene acetic acid and about 1.0 mg/L 6-benzylaminopurine; and
c. the rooting culture medium comprises about 1.0 mg/L indole-3-butyric acid.
